(19) United States
(12) Patent Application Publication
(10) Pub. No.: US 2026/0228354 A1
(43) Pub. Date: Aug. 6, 2026

(54) A SYSTEM FOR COMMUNICATING FILTERED CONTENT TO A REMOTE ENVIRONMENT

(71) Applicant: BRITISH TELECOMMUNICATIONS PUBLIC LIMITED COMPANY, London, Greater London (GB)

(72) Inventors: Max SMITH-CREASEY, London, Greater London (GB); Tiago MARTINS ANDRADE, London, Greater London (GB); Behnam AZVINE, London, Greater London (GB)

(21) Appl. No.: 19/152,811

(22) PCT Filed: Jan. 15, 2024
(86) PCT No.: PCT/EP2024/050776

§ 371 Date: Jul. 31, 2025

(30) Foreign Application Priority Data
Feb. 1, 2023 (EP) 23154451.1
Feb. 1, 2023 (GB) 2301427.7

(51) Int. Cl. G06F 21/62; G05B 13/02; G06F 21/32; G06V 20/52; G06V 40/10; G10L 17/02

(52) U.S. Cl. CPC G06F 21/6218; G05B 13/0265; G06F 21/32; G06V 20/52; G06V 40/10; G10L 17/02

(57) ABSTRACT

A System for Communicating Filtered Content to a Remote Environment The present application provides a method and system that allows a user to access and interact with a remote environment (e.g., a room at their place of work) through the use of a remotely controlled robotic system located in the remote environment. Sensor data captured by the robotic system is filtered in real-time in dependence on a security clearance level of the user, such that the user only receives data containing information that they are permitted to access. The remote user will be continuously authenticated (e.g., via biometrics), and based on the continuous authentication data presented by the user, associated security data will be communicated to the robotic system to determine the amount and type of filtering required for that user.

### TECHNICAL FIELD

Embodiments described herein relate generally to a method and system for communicating filtered sensor data from a robotic system to a remote computing device controlling the robotic system, the sensor data being filtered based on an authentication of the user of the remote computing device.

### BACKGROUND

It is becoming frequently common for people to work from home or another location remote from their office. In situations where immediate access to a room located at their workplace is required, extended reality or other computer systems may be implemented in order to allow the user to view and interact with the room remotely without needing to physically enter the room themselves. However, it may be the case that there are a variety of objects or information in that room that is highly sensitive and confidential, and not all members of staff may be permitted to access that information.

### SUMMARY OF INVENTION

A first aspect of the present disclosure provides a computer-implemented method of providing filtered sensor data to a computing device, the method comprising: obtaining sensor data using one or more sensors of a robotic system at a first location, the robotic system being remotely controlled by a computing device at a second location, processing the sensor data to identify one or more portions of sensor data comprising sensitive information, filtering the sensor data based on security information associated with a user of the computing device, wherein the security information is indicative of sensitive information that the user is authorised to receive, and outputting the filtered sensor data to the computing device.

As such, a user who is in a remote location different to that of the robotic system can use a computing device to control the robotic system remotely (e.g., the user may be located in their home office controlling a robotic system located at their place of work). The robotic system will then, in real-time, collect, process and filter sensor data (e.g., image data, audio data, infra-red data etc.), the filtered sensor data being sent back to the computing device of the user. The extent to which the sensor data is filtered will depend on the security clearance level associated with the user, such that any sensor data containing content that is sensitive or confidential and that the user is not authorised to access, will not be communicated back to the user. In doing so, the user is able to interact with the remote location without gaining unauthorised access to sensitive or confidential information.

The method may further comprise continuously receiving biometric data associated with the user of the computing device, and authenticating the user based on the received biometric data, wherein the authenticating comprises determining the security information associated with the user and outputting the security information to the robotic system. That is to say, whilst the user is in control of the robotic system, biometric data will be continuously received, for example, via one or more sensing means provided on the computing device, and used to verify the identity of the user and determine their security level. In doing so, if an unauthorised user or a user with a different security clearance level takes control of the computing device after the initial authentication, the robotic system will automatically filter the sensor data based on this change of security information (e.g., by maximally filtering all sensor data). The biometric data may comprise one or more of: a face, an eye movement, a fingerprint, a head movement and an input to a hand control. It will be appreciated that the authenticating may be performed by the computing device, the robotic system or by a further computing system in communication with the robotic system (e.g., a remote server associated with the first location).

In some cases, biometric data may be repeatedly received after a pre-determined interval of time. For example, new biometric data may be received every 5 to 10 minutes, or any other suitable interval of time. Biometric data may also be received each time the computing device sends a command to the robotic system.

Processing the sensor data may comprise comparing one or more portions of the sensor data to a database of sensitive information, wherein the database of sensitive information comprises a plurality of datasets, each dataset comprising an element of sensitive information and an associated sensitivity score. For example, each element of sensitive information may comprise one of: a word, object or person. Each sensitivity score may be indicative of a security clearance level needed to access the respective element of sensitive information.

For example, the comparing may comprise calculating a likelihood score for each of the one or more portions of sensor data based on a likelihood that the respective portion of sensor data contains an element of sensitive information.

Filtering the sensor data may comprise determining that the likelihood score of a portion of sensor data exceeds a predetermined threshold, comparing the sensitivity score of the respective element of sensitive information to the security information associated with the user, and removing or modifying the portion of sensor data if the user is not authorised to access the respective element of sensitive information.

In some arrangements, the sensor data may comprise a set of image data. For example, the image data may be a video stream. In such cases, processing the sensor data may comprise detecting at least one portion of image data comprising one or more of: a word, object and a person. The detecting may comprise using one or more machine learning algorithms. In this respect, any suitable convolutional neural network may be used, including but not limited to text recognition algorithms and real-time object detection algorithms. Filtering the sensor data may comprise removing, blurring, or replacing one or more portions of the image data. As such, if the image data captured by the robotic system contains a word, object or person that is sensitive or confidential, and the user of the computing device is not authorised to see this content, the images will be obfuscated in some way so that the word, object or person is not visible or recognisable from the images sent back to the computing device.

The sensor data may comprise a set of audio data. In such cases, processing the sensor data may comprises detecting at least one portion of audio data comprising one or more of: a word, and a voice of a person. The detecting may comprise using one or more machine learning algorithms, for example, a voice recognition algorithm such as dynamic time warping (DTW) may be used to detect any words being spoken, whilst a statistical technique such as Mel-frequency cepstral coefficients (MFCCs) to detect the identity of any voices. Filtering the sensor data may comprise removing, distorting, or replacing one or more portions of the audio data. For example, if the audio data captured by the robotic system contains any words that relate to confidential or sensitive information, that audio data may be replaced with silence or any sound such as white noise. Similarly, if the audio data contains the voice of someone whose identity is confidential, their voice may be distorted so as to protect their identity from the user of the computing device.

In some arrangements, the computing device may be part of an extended reality system, for example, the computing device may at least comprise a virtual reality headset. However, it will be appreciated that the computing device may be any computing device suitable for remotely controlling the robotic system, such as a desktop computer, laptop or smart phone.

A second aspect of the present invention provides a system comprising one or more processors, a non-transitory memory, and one or more programs, wherein the one or more programs are stored in the non-transitory memory and configured to be executed by the one or more processors, the one or more programs including instructions for performing any of the methods described above.

A further aspect of the present invention provides a non-transitory computer readable storage medium storing one or more programs, the one or more programs comprising instructions, which, when executed by an electronic device with one or more processors, cause the electronic device to perform any of the methods described above.

### BRIEF DESCRIPTION OF DRAWINGS

Further features and advantages of the present invention will become apparent from the following description of embodiments thereof, presented by way of example only, and by reference to the drawings, wherein:

FIG. 1 shows a representation of the overall system according to some embodiments;

FIG. 2 is a flow chart illustrating the method of using the system according to some embodiments;

FIG. 3 illustrates an example computer system used to implement part of the system shown in FIG. 1.

### DETAILED DESCRIPTION

Key terms related to embodiments of the present invention are explained in detail below.
Image Analysis: Object detection in images has reached a high level of sophistication in the last decade. With the new neural networks that can quickly identify objects in images in real-time (using a GPU for higher frame rates), real-time image filtering is very fast. Images can be further analysed using text recognition algorithms which may, again, be implemented via artificial neural networks.
Sensor Data Analysis: In the present disclosure, sensor data that might be analysed for sensitivity includes a microphone. It is well established that using statistical techniques such as Mel-frequency cepstral coefficients (MFCCs), it is possible to detect voices and the identity of those voices. Speech recognition techniques can also be used to detect what is being spoken. Other examples of sensor data that might be analysed for sensitivity include, but are not limited to, data collected by an infra-red sensor.
Continuous Authentication: Continuous authentication refers to the continual collection of biometrics from a device to authenticate a user.
XR Technologies: Virtual Reality (VR), Augmented Reality (AR) and Mixed Reality (MR): XR is an umbrella term that encompasses all the spectrum of extended reality technologies combining real and virtual environments such as AR, VR and MR, and everything in between. All technologies ranging from “the complete real” to “the complete virtual” experience are included. VR makes different cognitive interactions possible in a computer-generated environment, which models a 3D virtual space or virtual world. Typically, it uses a head-mounted display (HMD) to allow the user to visualise the virtual world, and which enables the user to navigate the environment, manipulate objects and perform a series of actions while perceiving the effects of those actions. Differently from VR, rather than creating a completely simulated environment, AR preserves the real environment and its surroundings, allowing the user to interact with 3D objects that are placed in the real-world environment. Since AR blends simulated objects and the real world, AR devices have the ability to understand the real world, by applying techniques such as motion tracking and light estimation. MR is defined by experiences that blur the lines between VR and AR. It is a combination of both VR and AR to produce new environments and visualizations where physical and digital object co-exist so that real or virtual objects can be added to virtual environments and virtual objects can be added to the real world.

### Overview

The present application provides a method and system that allows a user to access and interact with a remote environment (e.g., a room at their place of work) through the use of a remotely controlled robotic system located in the remote environment. The user may connect to and control the robotic system through a series of commands, whilst the robotic system obtains and transmits image sensor data and other sensor data (e.g., a microphone) back to the user. As one example, the user may interact with the robotic system via an extended reality system (e.g., a VR, AR or MR system), using a head-mounted device having a display and audio componentry, and one or more hand-held controllers. As another example, some other computing device, such as a desk-top computer, a laptop or mobile computing device, may be used to interact with and control the robotic system in the remote environment.

In some cases, the remote environment may contain objects and/or information that are highly confidential and secure, where only a subset of people have the security permissions required to access said objects and/or information. Similarly, the remote environment may be accessible by people whose identity is confidential and only known to people with the appropriate security permissions. As such, a user accessing the remote environment using the robotic system may not have all of the security permissions required to access all of the objects, information and/or people detected by the robotic system within the remote environment.

The present application thus provides a robotic system that provides real-time filtering of data collected within the remote environment in dependence on a security clearance level of the user. That is to say, sensor data collected by the robotic system is filtered and communicated to the user according to their security clearance level, such that the user only receives data containing information that they are permitted to access. The remote user will be continuously authenticated (e.g., via biometrics), and based on the continuous authentication data presented by the user, associated security data will be communicated to the robotic system to determine the amount and type of filtering required for that user.

The robotic system will then process the collected sensor data and filter the sensor data according to the filtering level required. For example, the robotic system may process image data to detect segments, locations and/or words that might correspond to sensitive information, and apply a machine learning technique to determine a score indicative of the likelihood that this information is sensitive. If that score is above a pre-defined threshold (e.g., set by the filtering level required for that user), the robotic system will filter the image data being communicated to the user in some suitable way, for example, by removing, blurring, or obfuscating the region containing the sensitive information. For example, the region comprising sensitive information may be a computer screen or a paper document, which can then be removed from the image data sent to the user, for example, using computer vision techniques. Sensitive information may also be detected in other sensor data, for example, in audio data collected by a microphone, before it is sent to the user. This might be done by removing portions of the audio data, for example, so that conversations relating to sensitive information are not transmitted to the user. Similarly, voices may be distorted before the audio feed is sent to the user, such that the identity of the person speaking cannot be recognised.

### Overview of the System

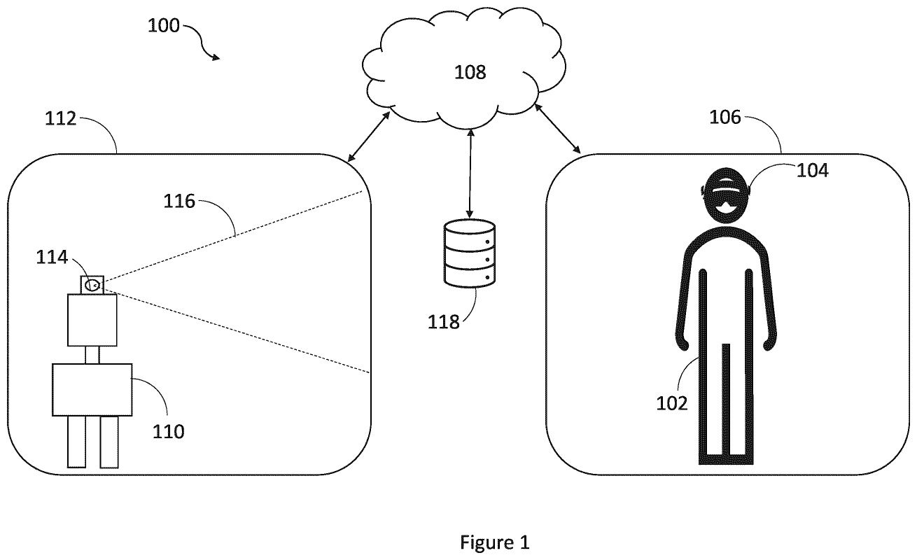

FIG. 1 illustrates an example of the system 100 used to implement the method described herein, comprising a user 102 at a first location 106 and robotic system 110 at a second location 112, the first location 106 being remote from the second location 112. In this example, the user 102 uses a computing device 104 to control the robotic system 110 within the second location 112. In this example, the computing device 104 is provided in the form of a head-mounted device that provides an extended reality interface (i.e., VR, AR or MR), which may be used in combination with one or more hand-held controllers (not shown) for receiving user input. The head-mounted computing device 104 may comprise, but not limited to, an internal display (e.g., a stereoscopic display providing separate images for each eye), a camera, an audio output, a microphone and one or more sensors. The sensors may include accelerometers, gyroscopes, and eye tracking sensors.

Whilst the systems and methods described herein relate to the use of an extended reality system to control the robotic system 110, it will be appreciated that any other computing device 104 may be used, including but not limited to, a desk-top computer, a laptop or mobile computing device (e.g., a smart phone), or any other computing device capable of receiving user input, communicating with the robotic system 110 and outputting data to the user 102.

In use, the head-mounted computing device 104 communicates with the robotic system 110 via a wireless network 108. In this respect, it will be appreciated that the head-mounted computing device 104 will also comprise transmitter and receiver componentry for sending and receiving wireless data communications. As will be described in more detail below, the user 102 will provide input commands to the head-mounted computing device 104, which will send these via the network 108 to the robotic system 110, to thereby control the robotic system 110.

The network 108 may be any suitable wireless network 108, such as a wireless local area network (WLAN) or a virtual private network (VPN). The network 108 may be connected to a central server 118 associated with the second location 112 (e.g., a server operated by an organisation having a place of business in which the robotic system 110 is located), to which both the robotic system 110 and the computing device 104 are connected. The server 118 may store security information comprising one or more user profiles associated with the second location and the respective security clearance level for each user profile. Additionally, or alternatively, this security information may be stored locally on the user computing device 104 and/or the robotic system 110.

The robotic system 110 is any machine that is capable of collecting sensor data and interacting with its environment 112. In this respect, the robotic system 110 comprises one or more sensors for capturing data associated with its environment. For example, the robotic system 112 comprises an image sensor 114 for capturing image data, for example, a video camera having a field of view illustrated generally by lines 116. The image sensor 114 may be configured to detect 2-dimensional or 3-dimensional image data of the environment 112. The robotic system 112 may also comprise a microphone or other audio input device (not shown) for detecting audio signals within the environment 110, as well as a speaker or other audio output device (not shown) for outputting audio signals received from the user 102.

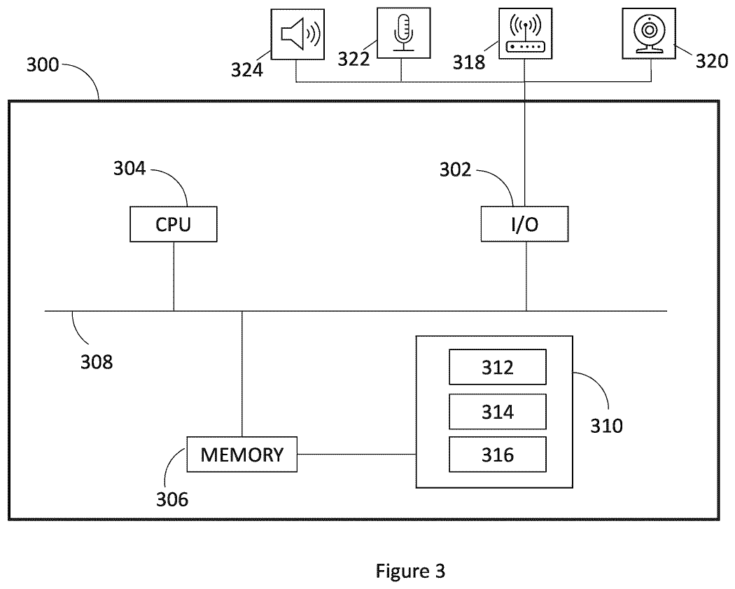

An example of a computing system 300 that may form part of the robotic system 110 is illustrated by FIG. 3. The computing system 300 comprises a processor 304 operable to execute machine code instructions stored in a working memory 306. By means of a general purpose bus 308, and an input/output interface 302 that is capable of communication with the processor 304. The input/output interface 302 is arranged to receive control inputs from the user 102 and output data to the user 102 via a transmitter/receiver device 318. The input/output interface 302 is also arranged to receive and output data via other devices, including but not limited to, an image sensor 320, an audio input device 322 and an audio output device 324. It will of course be appreciated that the input/output interface 302 may also communicate will any other device or sensor required for interacting with the environment 112 and collecting data associated therewith. Other examples of sensors that may be used as part of the system described herein include, but is not limited to, a motion sensor, a light sensor, an infra-red sensor, a smoke sensor, a fume sensor, or any other sensor suitable for capturing information about an environment.

The computing device 300 is also provided with a non-transitory computer readable storage medium 310 storing one or more programs configured to execute the method described herein, such as an image data processing program 312, a sensor data processing program 314 and a filtering program 316, as will be described in more detail below. It will however be appreciated that the computer readable storage medium 310 may comprise other programs comprising instructions for controlling the robotic system 110. It will also be appreciated that the image data processing program 312, sensor data processing program 314 and filtering program 316 may also be stored on the computer readable storage medium of some other computing system (e.g., the central server 118), such that the sensor data is captured by the robotic system 110 and sent to that computing system for processing and filtering before it is transmitted to the computing device 104 of the user 102.

### Method of Filtering Sensor Data Based on User Authentication

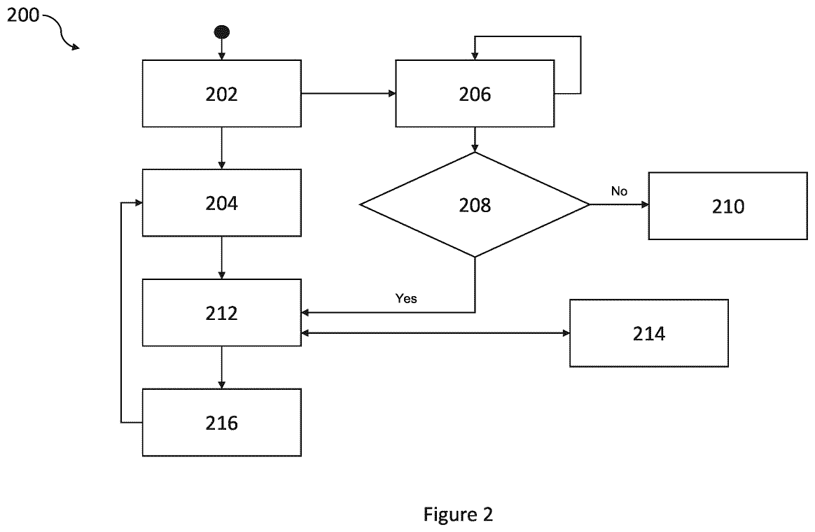

FIG. 2 illustrates a method 200 of using the system 100 described herein to provide filtered data to user 102 in a first location 106 controlling a robotic system 110 in a second location 112, wherein the data is filtered according to the security clearance of the user 102.

At step 202, the user 102 initiates communication with the robotic system 110, to thereby start controlling robotic system 110 within the second location 112. In this respect, the user 102 will input a request to the computing device 104 (e.g., a VR headset), which will then transmit the request to the robotic system 110 via the network 108 to initiate communication between the robotic system 110 and the user computing device 104.

At step 204, once communication has been initiated, the user 102 starts to input commands to the computing device 104 that are then relayed to the robotic system 110 via the network 108. In response to the commands, the robotic system 110 will begin to interact with its environment and collect sensor data. For example, the robotic system 110 may begin to move around the second location 110 according to the commands input by the user 102, or according to a pre-defined path stored in its memory 306. At the same time, the robotic system 110 may begin to collect sensor data, such as image data and audio data.

At step 206, in response to the initiated communication, the computing device 104 will start to collect biometric data from the user 102 in order to authenticate their identify. The user 102 may be authenticated through one or more of their movement (e.g., detected by an accelerometer), their face (e.g., detected by a camera), their eye movements (e.g., detected by an eye tracking sensor), their fingerprint (e.g., detected by a touch sensor), their voice (e.g., detected by a microphone), and the inputs to any hand controls. It will of course be appreciated however that any biometric data suitable for authentication may be collected, depending on the level of authentication required and the type of computing device 104 being used by the user 102.

At step 208, the collected biometric data is processed and compared to one or more user profiles associated with the second location 112 to authenticate the user and determine the security clearance level associated with that user profile. The comparison may be done using a suitable machine learning algorithm, such as a support vector machine, an artificial neural network, or a distance function algorithm. In this respect, each user profile associated with the second location 112 will be constructed over a training period to capture the biometric data required to train the algorithms. The machine learning algorithm may compare the biometric data to a single user profile (e.g., the user profile linked to the user computing device 104 being used) or to a plurality of user profiles (e.g., the user profiles of the employees of an organisation).

The process of authenticating the user 102 and determining their security clearance level may be performed by one or more of the user computing device 104, the central server 118 or the robotic system 110. For example, the user computing device 104 may be configured to compare the biometric data to the pre-defined user profile(s), to thereby confirm the user's identity. This authentication may then be sent to the server 118 or the robotic system 110 to extract the security information associated with the user profile and identify the security clearance level for that user 102. As another example, the collected biometric data may be sent to the central server 118, where it is processed and used to authenticate the user 102 and identify their security clearance level, this information then being sent to the robotic system 110 for use in filtering the sensor data.

At step 210, if the collected biometric data does not match any user profile, communication between the user computing device 104 and the robotic system 102 will be terminated and the user 102 will be locked out of the system.

If the collected biometric data does match a user profile, the security clearance level associated with the user profile will then be used at step 212 to filter the sensor data collected by the robotic system 110 before it is transmitted it back to the user 102.

To do this, the robotic system 110 will continuously capture sensor data, for example, image data and audio data, and process that sensor detect to detect whether that data contains any information that might be sensitive or confidential, using one or more machine learning techniques at step 214.

For image data, the image processing program 312 may use convolutional neural networks to detect regions of interest (e.g., containing a computer screen, a document or a person) in real-time, which are then processed to extract words, or to identify objects or people within the segments of image data corresponding to each region of interest. For example, text recognition algorithms (e.g., optical character recognition, Convolutional Recurrent Neural Network (CRNN) etc.) may be implemented using artificial neural networks to extract words in real-time as the image data is collected. Similarly, real-time object detection algorithms such as YOLO may be used to detect objects within the image data. The extracted words, objects or people are then analysed using further machine learning classification techniques to determine a likelihood that they are considered sensitive or confidential. To do this, the robotic system 110 will attempt to match the words, objects or people in that segment of image data to a database of sensitive information, which may be stored locally in the memory of the robotic system 110 or on the central server 118. For example, any words may be compared to a list of words associated with secure or confidential information, any objects may be compared to a list of objects associated with secure or confidential information, and any people may be compared to a list of personnel whose identify is restricted for one or more user profiles. It will be appreciated that any suitable machine learning techniques may be used to identify and compare people, objects and text within the image data to those stored in the database of sensitive information. For example, for people, a deep learning Convolutional Neural Network (CNN) may be used to identify and match the people in the image data with faces stored in the database of sensitive of information. For objects, object recognition may be performed using a Region-Based Convolutional Neural Network (R-CNN) or another real-time object detection algorithms such as YOLO. For text, any suitable algorithm may be used to detect and extract text, for example, a scene text detector such as Efficient and Accurate Scene Text Detector (EAST) may be used to detect text and a Convolutional Recurrent Neural Network (CRNN) may be used for text recognition. If there is a match between the image data and the database of sensitive information, then a likelihood score will be computed, for example, a likelihood score of 0 -100 may be given, where 100 indicates that the segment of image data contains information that is in the database. A sensitivity score for that sensitive information will also be obtained from the database, for example, a score of 1 to 5 with 5 being top secret, for use in determining the level of filtering required, as will be described below.

For other sensor data, such as audio data, the sensor data processing program 314 may use a voice recognition algorithm such as dynamic time warping (DTW) to detect any words being spoken. These words will then be analysed to determine whether they relate to sensitive or confidential information by again comparing the words to a database of sensitive information, and computing a likelihood score indicating the likelihood that the word matches an item of sensitive information in the database. As before sensitivity score for that sensitive information will also be obtained from the database.

Audio data may also be analysed using statistical techniques such as Mel-frequency cepstral coefficients (MFCCs) to detect the identity of any voices. This may then be compared to the database of sensitive information to determine a likelihood score indicating the likelihood that the voice identified corresponds to a person whose identify is restricted for one or more user profiles. As before, a sensitivity score for the person listed in the database will be obtained.

It will of course be appreciated that the sensor data processing program 314 may be used to process other data collected by one or more sensors of the robotic system 110. For example, in the case of an infra-red sensor, the output is a black and white image or video, and so similar processing techniques as those described with respect to the image data may be performed to identify any information that could be sensitive or confidential.

Once the likelihood scores and corresponding sensitivity scores have been determined for each segment of image and audio data (or other sensor data), the sensor data is filtered according to the security clearance level of the user profile associated with the user 102, for example, using the filtering program 316. For each segment of sensor data that has been assessed for sensitive information, if the likelihood score of any of the content within that segment is above a pre-defined threshold (for example, 50 or above), the sensitivity score for that content be compared to the security clearance level of the user 102. For example, if the segment of sensor data comprises a word that has a likelihood score of 80 and a sensitivity score of 4, this segment will be filtered if the user profile indicates that the user 102 is only permitted to see information with a sensitivity score of 3 or less. Of course, if the user profile indicates that the user 102 can see information with a sensitivity score of 4, then no filtering is required. It will of course be appreciated that if a plurality of words or objects within an image segment has been identified as being sensitive, the word or object having the highest associated sensitivity score will determine the left of filtering required.

For filtering image data, the segment of image data that has been detected as having sensitive information may be blurred, replaced, removed, or obfuscated in some way, for example, by replacing that image segment with black pixels. In this respect, for each image segment, the [x, y] coordinates of the region containing sensitive information is all that is needed to filter that region out. This would render the sensitive region of the image unviewable and maintain its security. In some cases, it will be appreciated that, for each image segment containing sensitive information, only the words or objects within each segment will be filtered, and in other cases, the surrounding areas of those words or objects will also be filtered to ensure no other potentially sensitive information is revealed (e.g., words or objects that are not sensitive in isolation but could be used to deduce confidential information if only key items are removed or blurred).

When filtering image data, if a face or person is detected and the identify of that person is restricted, the image data may be altered by generating an avatar and placing it over the person to hide their identity. It will of course be appreciated that some other method of hiding the person's identity may also be used (e.g., by blurring or obfuscating the image as described above). The user 102 controlling the robotic system 110 may still interact with the person behind the avatar (e.g., via the speaker 324 and microphone 322 of the robotic system 110), but without the identity of the person being revealed. Furthermore, by hiding the person behind an avatar, it allows the user 102 to know the exact location of that person, so that they can avoid colliding into the person with the robotic system 110.

To filter audio data, the portion of audio data containing any sensitive information may be replaced with white noise, silence or any other suitable sound so that any audio containing sensitive word(s) is not sent to the user 102. Additionally, in the case of a person whose identity is restricted, their voice may be distorted in some way, for example, using any voice changing software capable of changing the amplitude, pitch and/or tone of a voice, so that the user 102 can still interact with the person in the second location 112 but without hearing their real voice, which might otherwise give away their identity.

Once the sensor data has been filtered as necessary, it is then transmitted back to the user computing device 104 at step 216. In some cases, the filtered sensor data may be sent to the user computing device 104 in an encrypted form, the user computing device 104 storing the necessary encryption keys to decrypt the filtered sensor data.

It will be appreciated that user authentication performed in steps 206 and 208 will be performed in parallel with step 204. As such, if the user 102 is authenticated, the robotic system 110 will collect, filter and transmit data to the user 102 substantially in real-time with the user commands. In this respect, the collecting and filtering of sensor data at step 212 and 214, as described above, will be performed substantially in real-time as commands are received and executed by the robotic system 110. That is to say, there will be a minimal lag time between the user 102 sending a command and then receiving filtered sensor data (e.g., images and audio) from the robotic system 110.

Additionally, the user computing device 104 will periodically collect biometric data from the user 102, which is then used to authenticate the user 102 as described with reference to step 208. As one example, the biometric data may be repeatedly collected after a predetermined time period, for example, every 5 to 10 minutes. Alternatively, or additionally, the biometric data may be collected each time the user 102 sends a command to the robotic system 110. Consequently, if an unauthorised person was to take over the computing device 104 after the initial authentication was performed, the system will detect a change in the identity of the user 102 and either lock the new user out of the system (i.e., such that the user can no longer control the robotic system 110 or receive sensor data), or maximally filter all sensor data being sent back to the computing device 104. It will be appreciated that the frequency with which biometric data is collected and authenticated may depend on the level of security required within the second location 112.

Examples of the method and system in use will now be described.

### Examples of Use—Example 1

In one example, the user 102 is an engineer, who works for a technology company. The remote engineer 102 is working from home (i.e., remote location 106), but needs to access a secure laboratory (i.e., secure environment 112) at the headquarters of the company to look at some equipment that is in the lab 112. The remote engineer 102 is able to do this by taking remote control of a robotic system 110 located in the laboratory using a VR system 104.

The remote engineer 102 initiates communication with the robotic system 110 through the VR system 104, and starts to control the robotic system 110 through their inputs to the VR system 104. For example, the remote engineer 102 may use hand controls or voice inputs to a microphone to instruct the robotic system 110 to move within the secure environment 112 towards the equipment it needs to examine. At the same time, the VR system 104 collects one or more sets of biometric data, as described above, and processes this biometric data to identify a user profile associated with the technology company (i.e., to confirm that the remote engineer 102 works at the company), and determine the security clearance level of the engineer. For example, the security clearance level may indicate that the remote engineer 102 is permitted to access information having a sensitivity level 4 or below. This authentication and security information will then be communicated to the robotic system 110 for use in filtering the sensor data that it collects. As before, this process of authentication is continuously repeated for the duration that the robotic system 110 is under the control of the remote engineer 102, for example, every 5 minutes or each time a command is sent to the robotic system 110 via the VR system 104.

As the robotic system 110 collects sensor data (e.g., image and audio data), it processes the sensor data to detect any information that could be considered sensitive and which the remote engineer 102 is not permitted to access. As the robotic system 110 moves around the room 112, it captures some image data (i.e., a video stream) that shows a computer screen and some documents that are being used by another engineer who is in the room 112, and some audio data that captures the other engineer speaking (e.g., in response to the remote engineer 102 speaking through the robotic system 110).

The image data is processed as segments, with the segments containing the computer display, the documents and the other engineer being detected as regions of interest. The robotic system 110 then processes these regions of interest to extract any words or objects that might be contained within a database of sensitive information and determine a respective likelihood score. In this case, some of the segments are found to contain one or more words of a sensitive nature, each with a likelihood score of at least 90, meaning that it is very likely that they match with the word(s) in the database of sensitive information. A sensitivity score is then obtained for each word that has been matched, and it is found that the words all have a sensitivity score of 5.

In some other image segments, a person whose identity may be sensitive (i.e., the other engineer) is detected, again with a likelihood score of 90. A sensitivity score is then obtained for the person that has been matched, and it is found that this person has a sensitivity score of 3.

Consequently, as the remote engineer 102 is permitted to see information with a security level of 4 or below, the robotic system 110 applies a filter to the image segments containing the identified words such that those words (and the surrounding areas) are blurred or pixelated, but does not apply a filter to portions of the image segments containing the other engineer.

The audio data is also processed in a similar way to determine whether the other engineer is discussing anything that should not be heard by the remote engineer 102. In this respect, the audio data is processed to extract words and compare them to the database of sensitive information. In this case, the likelihood score of the words detected in the audio data is calculated as being 20 or below, meaning that it is very unlikely that the content of the audio data relates to confidential or sensitive information. As this does not exceed a predetermined threshold of 50, it is determined that no filtering is required to the audio data. As such, the remote engineer 102 may conduct a conversation with the other engineer without the audio data being filtered, provided that the other engineer does not discuss anything that the remote engineer 102 is not authorised to hear. As the collecting, processing and filtering of sensor data happens in substantially real-time, if the other engineer was to start talking about something that the remote engineer 102 does not have the required security clearance for, the audio data will be immediately filtered so that the remote engineer 102 hears either silence or white noise.

### Example of Use—Example 2

As a further example, the user 102 is a security guard, who works for a financial company. The security guard 102 has received a message that there is a potential issue in one of the secure rooms (i.e., secure location 112) within the building. As the security guard 102 is not authorised to enter the secure room 112 in person, the security guard 102 is able to assess the situation by taking remote control of a robotic system 110 located in the secure room 112, for example, using their mobile phone (i.e., computing device 104).

The security guard 102 initiates communication with the robotic system 110 through the mobile phone, and starts to control the robotic system 110 through their inputs to the mobile phone. For example, the security guard 102 may use the touch screen of the mobile phone or voice inputs to a microphone to instruct the robotic system 110 to move within the secure environment 112, for example, towards a person in the room so that they can interact with that person to find out what the issue is. At the same time, the mobile phone collects one or more sets of biometric data, as described above, and processes this biometric data to identify a user profile associated with the financial company (i.e., to confirm that the security guard 102 works at the company), and determine the security clearance level of the security guard. For example, the security clearance level may indicate that the security guard 102 is permitted to access information having a sensitivity level 2 or below. This authentication and security information will then be communicated to the robotic system 110 for use in filtering the sensor data that it collects. As before, this process of authentication is continuously repeated for the duration that the robotic system 110 is under the control of the security guard 102, for example, every 5 minutes.

As the robotic system 110 collects sensor data (e.g., image and audio data), it processes the sensor data to detect any information that could be considered sensitive and which the security guard 102 is not permitted to access. As the robotic system 110 moves around the room 112, it again captures image data (i.e., a video stream) that shows a computer screen and some documents that are being used by the people in the room 112, and some audio data that captures the people speaking (e.g., in response to the security guard 102 speaking through the robotic system 110).

The image data is processed as segments, with the segments containing the computer display, the documents and the people being detected as regions of interest. The robotic system 110 then processes these regions of interest to extract any words or objects that might be contained within a database of sensitive information and determine a respective likelihood score. In this case, some of the segments are found to contain one or more words of a sensitive nature, each with a likelihood score of at least 75, meaning that it is likely that they match with the word(s) in the database of sensitive information. A sensitivity score is then obtained for each word that has been matched, and it is found that the words all have a sensitivity score of 3.

In some other image segments, one or more people whose identity may be sensitive is detected, with a likelihood score of 80. A sensitivity score is then obtained for each person that has been matched; most of the people in the room have a sensitivity score of 2, but one person has a sensitivity score of 4.

Consequently, as the security guard 102 is permitted to see information with a security level of 2 or below, the robotic system 110 applies a filter to the image segments containing the identified words such that those words (and the surrounding areas) are blurred or pixelated, thereby preventing the security guard 102 from seeing any confidential information. For the people having a sensitivity score of 2, no filter is required to hide or replace the image data showing these people. However, for the person having a sensitivity score of 4, an avatar is provided over the portion of the image segment containing this person. In doing so, the security officer 102 is able to see that there is an additional person in the room, without their identity being revealed.

The audio data is also processed in a similar way to determine whether the people in the room are discussing anything that should not be heard by the security guard 102, and whether any of the voices belong to people whose identity is confidential. In this respect, the audio data is processed to extract words and compare them to the database of sensitive information. In this case, the likelihood score of the words detected in the audio data is calculated as being 10 or below, meaning that it is very unlikely that the content of the audio data relates to confidential or sensitive information. As this does not exceed a predetermined threshold of 40 (e.g., set by the financial company), it is determined that no filtering is required to the audio data in this respect. The audio data is also processed to detect the identity of the voices, and as expected, one of the voices is matched as belonging to a person with a sensitivity score of 4, with a likelihood score of 80. Consequently, the audio data corresponding to the voice of that person is distorted so as to not reveal their identity. As such, the security guard 102 can conduct a real-time conversation with all of the people in the room to find out what the problem is, without the identity of those with a particular security level being revealed.

The above discussed method may be performed using one or more computer systems or similar computational resources, or systems comprising one or more processors and a non-transitory memory storing one or more programs configured to execute the method. Likewise, a non-transitory computer readable storage medium may store one or more programs that comprise instructions that, when executed, carry out the method providing filtered content to a computer system being used to control a remote robot device.

Whilst certain embodiments have been described, these embodiments have been presented by way of example only, and are not intended to limit the scope of the application. Indeed, the novel devices, and methods described herein may be embodied in a variety of other forms; furthermore, various omissions, substitutions and changes in the form of the devices, methods and products described herein may be made without departing from the scope of the present application. The word “comprising” can mean “including” or “consisting of” and therefore does not exclude the presence of elements or steps other than those listed in any claim or the specification as a whole. The mere fact that certain measures are recited in mutually different dependent claims does not indicate that a combination of these measures cannot be used to advantage. The accompanying claims and their equivalents are intended to cover such forms or modifications as would fall within the scope of the application.

1. A computer-implemented method of providing filtered sensor data to a computing device, the method comprising:
obtaining sensor data using one or more sensors of a robotic system at a first location, the robotic system being remotely controlled by a computing device at a second location;
processing the sensor data to identify one or more portions of sensor data comprising sensitive information;
filtering the sensor data based on security information associated with a user of the computing device, wherein the security information is indicative of sensitive information that the user is authorised to receive; and
outputting the filtered sensor data to the computing device.

2. A method according to claim 1, further comprising:
continuously receiving biometric data associated with the user of the computing device; and
authenticating the user based on the received biometric data, wherein the authenticating comprises determining the security information associated with the user and outputting the security information to the robotic system.

3. A method according to claim 2, wherein biometric data is repeatedly received after a pre-determined interval of time.

4. A method according to claim 2, wherein biometric data is received each time the computing device sends a command to the robotic system.

5. A method according to claim 1, wherein processing the sensor data comprises comparing one or more portions of the sensor data to a database of sensitive information, wherein the database of sensitive information comprises a plurality of datasets, each dataset comprising an element of sensitive information and an associated sensitivity score.

6. A method according to claim 5, wherein the comparing comprises calculating a likelihood score for each of the one or more portions of sensor data based on a likelihood that the respective portion of sensor data contains an element of sensitive information.

7. A method according to claim 6, wherein filtering the sensor data comprises:
determining that the likelihood score of a portion of sensor data exceeds a predetermined threshold;
comparing the sensitivity score of the respective element of sensitive information to the security information associated with the user; and
removing or modifying the portion of sensor data if the user is not authorised to access the respective element of sensitive information.

8. A method according to claim 1, wherein the sensor data comprises a set of image data.

9. A method according to claim 8, wherein processing the sensor data comprises detecting at least one portion of image data comprising one or more of: a word, object and a person.

10. A method according to claim 8, wherein filtering the sensor data comprises removing, blurring, or replacing one or more portions of the image data.

11. A method according to claim 1, wherein the sensor data comprises a set of audio data.

12. A method according to claim 11, wherein processing the sensor data comprises detecting at least one portion of audio data comprising one or more of: a word, and a voice of a person.

13. A method according to claim 8, wherein filtering the sensor data comprises removing, distorting, or replacing one or more portions of the audio data.

14. A system comprising:
one or more processors;
a non-transitory memory; and
one or more programs, wherein the one or more programs are stored in the non-transitory memory and configured to be executed by the one or more processors, the one or more programs including instructions for performing any of the methods of claim 1.

15. A non-transitory computer readable storage medium storing one or more programs, the one or more programs comprising instructions, which, when executed by an electronic device with one or more processors, cause the electronic device to perform any of the methods of claim 1.
